(19) United States
(12) Patent Application Publication
(10) Pub. No.: US 2018/0249267 A1
(43) Pub. Date: Aug. 30, 2018

(54) PASSIVE MICROPHONE ARRAY LOCALIZER

(71) Applicant: Apple Inc., Cupertino, CA (US)

(72) Inventors: Daniel C. Klingler, Mountain View, CA (US); Jay S. Coggin, Mountain View, CA (US)

(21) Appl. No.: 15/754,914

(22) PCT Filed: Aug. 31, 2015
(86) PCT No.: PCT/US2015/047825

§ 371 Date: Feb. 23, 2018

(51) Int. Cl. H04R 29/00; H04R 1/40; G01S 5/26; G01S 3/802

(52) U.S. Cl. CPC H04R 29/005; G01S 3/802; G01S 5/26; H04R 1/406

(57) ABSTRACT

A relative location and orientation of microphone arrays relative to each other is estimated without actively producing test sounds. In one instance, the relative location and orientation of a second microphone array relative to a first microphone array is estimated based on the direction-of-arrival (DOA) of an ambient sound at the first microphone array, the DOA of the ambient sound at the second microphone array, and the time-difference-of-arrival (TDOA) of the ambient sound between the first microphone array and the second microphone array. Other embodiments are also described and claimed.

### FIELD

An embodiment of the invention is related to passively localizing microphone arrays without actively producing test sounds. Other embodiments are also described.

### BACKGROUND

A microphone array is a collection of closely-positioned microphones that operate in tandem. Microphone arrays can be used to locate a sound source (e.g., acoustic source localization). For example, a microphone array having at least three microphones can be used to determine an overall direction of a sound source relative to the microphone array in a 2D plane. Given multiple microphone arrays positioned in a space (e.g., in a room), it may be useful to determine a relative location and orientation of one microphone array relative to the other microphone arrays.

Existing approaches for determining the relative location and orientation of a microphone array relative to other microphone arrays rely on actively producing test sounds (e.g., playing music or playing a test tone such as a sweep test tone or a maximum length sequence (MLS) test tone). However, producing test sounds requires setting up and configuring additional equipment (e.g., device to generate sound content and speakers) in addition to the microphone arrays. Moreover, producing test sounds may not always be practical (e.g., in a quiet space such as a library) and may cause a disturbance.

### SUMMARY

In accordance with an embodiment of the invention, a method for estimating relative location and relative orientation of microphone arrays, relative to each other, without actively producing test sounds may proceed as follows (noting that one or more of the following operations may be performed in a different order than described.) The method proceeds with determining a first direction from which an ambient sound is received at a first microphone array (e.g., first Direction Of Arrival, DOA), wherein the ambient sound is received at the first microphone array at a first time. A second direction is determined from which the ambient sound is received at a second microphone array (e.g., second DOA), wherein the ambient sound is received at the second microphone array at a second time. A difference or delay between the first and second times at which the ambient sound is received at the first microphone array and the second microphone array (e.g., a Time Difference or Delay Of Arrival, TDOA) is also determined. A relative location and a relative orientation of the second microphone array, relative to the first microphone array, is estimated, based on the first direction from which the ambient sound is received at the first microphone array, the second direction from which the ambient sound is received at the second microphone array, and the difference between the first and second times at which the ambient sound is received at the first microphone array and the second microphone array.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, a given figure may be used to illustrate the features of more than one embodiment of the invention in the interest of reducing the total number of drawings, and as a result, not all elements in the figure may be required for a given embodiment.

FIG. 1 is a diagram illustrating two microphone arrays and their relative location and orientation relative to each other, according to some embodiments.

FIG. 2 is a diagram illustrating two microphone arrays detecting an ambient sound from a sound source, according to some embodiments.

FIG. 3 is a block diagram illustrating a system for estimating the relative location and orientation of one microphone array relative to another microphone array, according to some embodiments.

FIG. 4 is a flow diagram illustrating a process for estimating the relative location and orientation of one microphone array relative to another microphone array, according to some embodiments.

### DETAILED DESCRIPTION

Several embodiments of the invention with reference to the appended drawings are now explained. Whenever aspects of the embodiments described here are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

Embodiments estimate a relative location and relative orientation of one microphone array relative to another microphone array without actively producing test sounds. Embodiments rely on ambient sounds in the environment to localize the microphone arrays relative to each other.

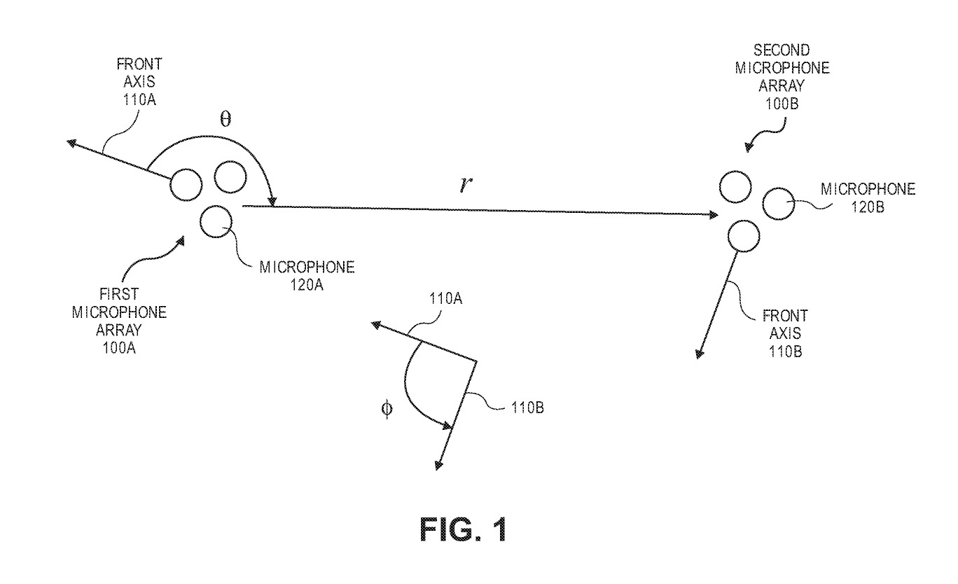

FIG. 1 is a diagram illustrating two microphone arrays and their relative location and orientation relative to each other, according to some embodiments. FIG. 1 illustrates a first microphone array 100A and a second microphone array 100B. As shown, the first microphone array 100A includes an array of three microphones 120A. Similarly, the second microphone array 100B includes an array of three microphones 120B. Although the drawings show each of the microphone arrays 100 as having an array of three microphones 120, each microphone array 100 can have any number of microphones 120. In one embodiment, the first microphone array 100A may have a different number of microphones 120 than the second microphone array 100B. In general, increasing the number of microphones 120 in a microphone array 100 may provide more accurate measurements of sound (e.g., measurements of the direction-of-arrival of a sound) and thus produce a better estimate of the relative location and orientation of the microphone arrays 100 relative to each other. In general, three or more microphones 120 are needed to accurately determine the overall direction of a sound arriving at a microphone array 100 in a 2D plane. Four or more microphones 120 may be needed to accurately determine the overall direction of a sound arriving at the microphone array 100 in 3D space.

The first microphone array 100A has a predefined front reference axis 110A that extends outwardly from the first microphone array 100A. The second microphone array 100B also has a predefined front reference axis 110B that extends outwardly from the second microphone array 100B. Knowledge of the orientation of the front reference axis 110 relative to the positions of the individual microphones (in each array 100) may be stored in electronic memory (e.g., together with a wireless or wired transceiver, a digital processor, and/or other electronic components, within a housing or enclosure that also contains the individual microphones of the array 100.) Embodiments estimate a relative location and relative orientation of the second microphone array 100B relative to the first microphone array 100A. In one embodiment, the relative location of the second microphone array 100B relative to the first microphone array 100A can be expressed in terms of a polar coordinate, (r, θ), where r is the distance of a straight line between, for example, the respective centers of the first microphone array 100A and the second microphone array 100B, and where θ is an angle formed between the front reference axis 110A of the first microphone array 100A and the straight line that connects the first microphone array 100A to the second microphone array 100B. In one embodiment, the relative orientation of the second microphone array 100B relative to the first microphone array 100A is an angle φ formed between the front reference axis 110A of the first microphone array 100A and the front reference axis 110E of the second microphone array 100B. The location and orientation of the microphone arrays 100 are shown by way of example, and not limitation. In other embodiments, the microphone arrays 100 may be positioned in different configurations than shown in FIG. 1.

An embodiment is able to estimate the relative location (e.g., (r, θ)) and orientation (e.g., φ) of the microphone arrays 100 relative to each other without actively producing test sounds. Embodiments detect ambient sounds present in the environment and use information gathered from these ambient sounds to estimate the relative location and orientation of the microphone arrays 100 relative to each other. The information gathered from the ambient sounds is dependent on the relative location and orientation of the microphone arrays 100. This dependence can be used to extract the relative location and orientation of the microphone arrays 100, as will be described in additional detail below. The descriptions provided herein primarily describe techniques for estimating the relative location and orientation of the microphone arrays 100 relative to each other in a 2D plane. However, the techniques described herein can be extended/modified to extend to 3D space as well.

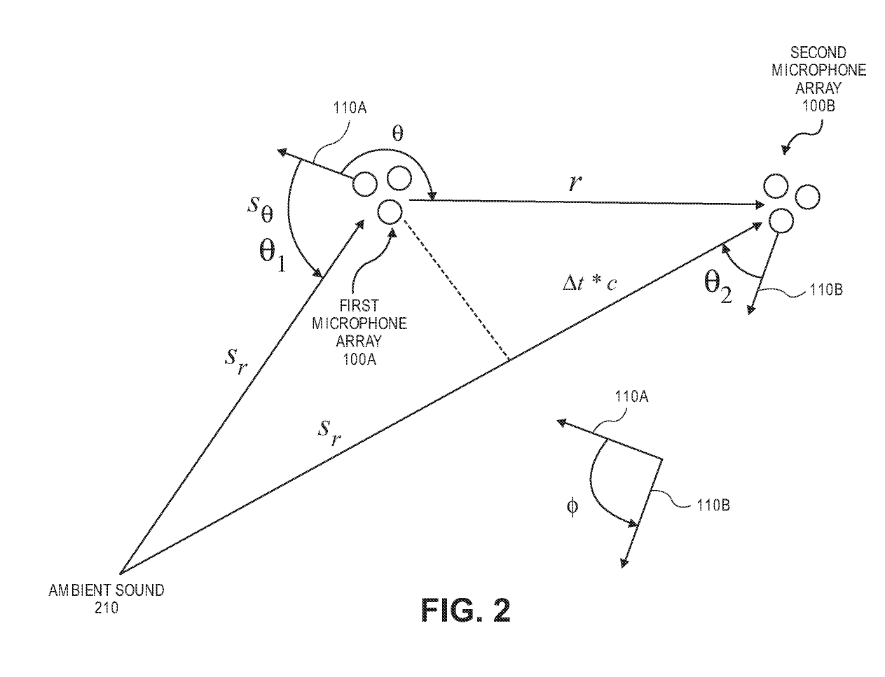

FIG. 2 is a diagram illustrating two microphone arrays detecting an ambient sound from a sound source, according to some embodiments. An ambient sound 210 is produced by a sound source located at a particular location. The sound waves of the ambient sound 210 travel towards the first microphone array 100A and the second microphone array 100B. The distance formed by a straight line that connects the sound source to the first microphone array 100A is denoted as sᵣ. The angle that is formed between the front axis 110A of the first microphone array and the straight line that connects the sound source to the first microphone array 100A is denoted as s_{θ}. As such, the location of the sound source is at a location (sᵣ, s_{θ}) (in polar coordinates) relative to the first microphone array 100A.

A computation of a direction-of-arrival (DOA) of the ambient sound 210 at the first microphone array 100A can be made, based on the known configuration of the microphones of the first microphone array 100A and relative times that each microphone of the array 100A receives the ambient sound 210. In one embodiment, the DOA of the ambient sound 210 at the first microphone array 100A is measured relative to the front axis 110A of the first microphone array 100A. For example, the DOA of the ambient sound 210 at the first microphone array 100A is an angle θ₁ formed between the front axis 110A of the first microphone array and the direction that the ambient sound 210 arrives at the first microphone array 100A. Similarly, a computation of a DOA of the ambient sound 210 at the second microphone array 100B can be made, based on the known configuration of the microphones of the second microphone array 100B and relative times that each of the microphone of the array 100B receives the ambient sound 210. In one embodiment, the DOA of the ambient sound 210 at the second microphone array 100B is measured relative to the front axis 110E of the second microphone array 100B. For example, the DOA of the ambient sound 210 at the second microphone array 100B is an angle θ₂ formed between the front axis 110E of the second microphone array 100B and the direction that the ambient sound 210 arrives at the second microphone array 100B.

Depending on the distance of the sound source to each of the microphone arrays 100, the ambient sound 210 may arrive at the microphone arrays 100 at different times (if the microphone arrays 100 are equidistant from the sound source, the ambient sound 210 may arrive at the microphone arrays 100 at the same time). As shown in the example of FIG. 2, the ambient sound 210 arrives at the first microphone array 100A first and then arrives at the second microphone array 100B following a time interval t (e.g., milliseconds) delay. This time-difference-of-arrival (TDOA) of the ambient sound 210 between the first microphone array 100A and the second microphone array 100B is denoted as At. Thus, the ambient sound 210 needs to travel an additional distance of Δt*c (where c represents the speed of sound) to reach the second microphone array 100B compared to the distance traveled to reach the first microphone array 100A (distance sᵣ).

When an ambient sound event is detected by using the microphone arrays 100, the following three pieces of information can be captured: 1) the DOA of the ambient sound 210 at the first microphone array 100A (θ₁); 2) the DOA of the ambient sound 210 at the second microphone array 100B (θ₂); and 3) the TDOA of the ambient sound 210 between the first microphone array 100A and the second microphone array 100B (Δt). These three pieces of information constitute an observation vector y:

$$y = [ \begin{matrix}{θ}_{1} \\ {θ}_{2} \\ Δ t\end{matrix} ]$$

Suppose the configuration of the microphone arrays 100 relative to each other is known (e.g., r, θ, and φ are known). For a given sound source location (e.g., given sᵣ and s_{θ}), the expected observation vector for sound produced by the sound source can be calculated using trigonometry (e.g., see Equations 2, 3, and 4 discussed below). This can be represented as a vector-valued function, ƒ, that is parametrized on r, θ, and φ. This vector-valued function takes the sound source location vector x as input and produces an ideal observation vector y:

The image of the function (e.g., the set of allowable outputs) is dependent on the parameters r, θ, and φ, and lies in a subspace of the codomain. The goal is to find the set of parameters that cause the set of real-world observations to lie as close as possible to the image of ƒ. When the set of parameters are correct, the real-world observations lie close to the image of this function because this function correctly models how the observations are produced in the physical world. Mathematically, the goal is to adjust the parameters to minimize the average distance from the real-world observations to the image of ƒ. In a noiseless world, it would be possible to find the parameters that cause all the real-world observations to lie in the image of ƒ. However, when the observations are noisy, the real-world observations do not lie exactly in the image of ƒ. Thus, in one embodiment, a least-squares solution will be used to provide an estimate of the relative location and orientation of the microphone arrays 100 (to each other).

For example, solving the following equation provides a least-squares solution, given a set of N observations (N ambient sounds):

$$\{ r , θ , φ \} = {arg min}_{r , θ , φ} {\sum }_{i = 1}^{N} {min}_{{x}_{i}} ‖ {f}_{r , θ , φ} ( {x}_{i} ) - {y}_{i} ‖ \qquad Equation 1$$

In Equation 1, xᵢ is the sound source location vector (e.g., including sᵣ and s_{θ} as elements) of the i-th ambient sound and yᵢ is the observation vector (e.g., including θ₁, θ₂, and Δt as elements) for the i-th ambient sound. There are a variety of techniques to optimize this equation, which is a non-linear function. In one embodiment, a brute force search over the parameter space can be performed to find the optimal solution. In one embodiment, three observations (N=3) obtained from three different ambient sounds originating from different locations are used to estimate the relative location and orientation of the microphone arrays. However, using more observations may produce better estimates.

The following equalities may be used for optimizing Equation 1:

$$\begin{matrix}{θ}_{1} = {s}_{θ} & Equation 2 \\ {θ}_{2} = sgn ( sin ( θ - {s}_{θ} ) ) arccos ( \frac{( r - {s}_{r} cos ( θ - {s}_{θ} ) )}{\sqrt{{s}_{r}^{2} + {r}^{2} - 2 {s}_{r} r cos ( θ - {s}_{θ} )}} ) & Equation 3 \\ Δ t = \frac{r sin ( \begin{matrix}θ - {s}_{θ} - sgn ( sin ( θ - {s}_{θ} ) ) arccos \\ ( \frac{( r - {s}_{r} cos ( θ - {s}_{θ} ) )}{\sqrt{{s}_{r}^{2} + {r}^{2} - 2 {s}_{r} r cos ( θ - {s}_{θ} )}} )\end{matrix} )}{sin ( \begin{matrix}- θ + {s}_{θ} - sgn ( sin ( θ - {s}_{θ} ) ) arccos \\ ( \frac{( r - {s}_{r} cos ( θ - {s}_{θ} ) )}{\sqrt{{s}_{r}^{2} + {r}^{2} - 2 {s}_{r} r cos ( θ - {s}_{θ} )}} )\end{matrix} )} & Equation 4\end{matrix}$$

The process described above is thus an example of how the relative location and the relative orientation of two microphone arrays can be estimated, by minimizing an average distance between a) measurements of at least three different ambient sounds originating from different locations, wherein each measurement of an ambient sound includes 1) a direction at which that ambient sound is received at the first microphone array at a first time, 2) a direction at which that ambient sound is received at the second microphone array at a second time, and 3) a difference between the first and second times at which the ambient sound is received at the first microphone array and the second microphone array, and b) an image of a function that maps sound locations to expected values of DOA and TDOA for a given microphone array configuration, and wherein the function is parameterized on the relative location and the relative orientation of the second microphone array relative to the first microphone array.

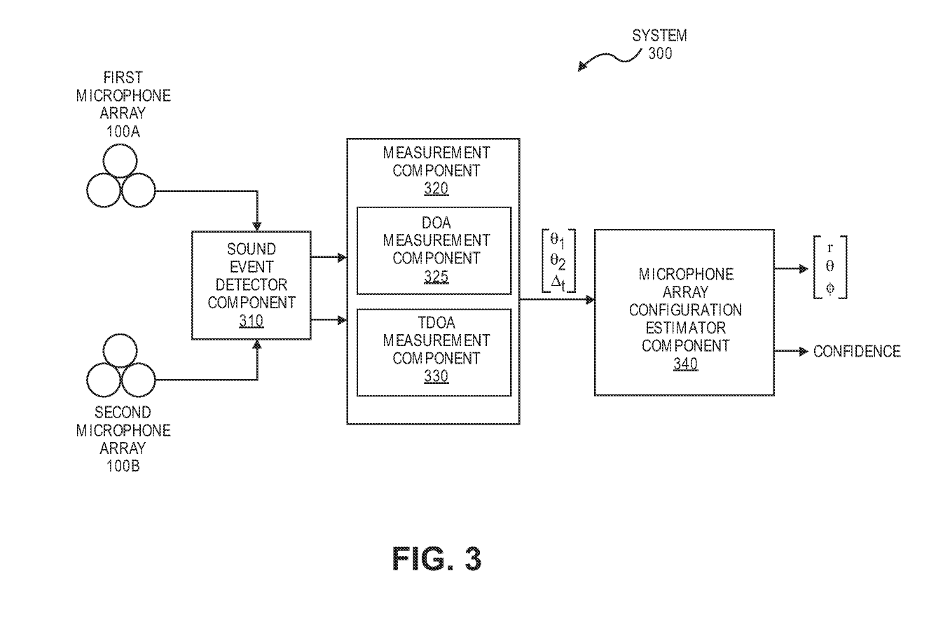

FIG. 3 is a block diagram illustrating a system for estimating the relative location and orientation of one microphone array relative to another microphone array, according to some embodiments. The system 300 includes a first microphone array 100A, a second microphone array 100B, a sound event detector component 310, a measurement component 320, and a microphone array configuration estimator component 340. The components of the system 300 may be implemented based on application-specific integrated circuits (ASICs), a general purpose microprocessor, a field-programmable gate array (FPGA), a digital signal controller, a set of hardware logic structures, or any combination thereof. The components of the system 300 are provided by way of example and not limitation. For example, in other embodiments, some of the operations performed by the components may be combined into a single component or distributed amongst multiple components in a different manner than shown in the drawings.

The first microphone array 100A and the second microphone array 100B each include an array of microphones. As shown, the first microphone array 100A and the second microphone array 100B each include an array of three microphones. However, as mentioned above, each microphone array 100 can have any number of microphones and each microphone array 100 can have different number of microphones or the same number of microphone. Each microphone array 100 is positioned at a given location and in a given orientation.

In one embodiment, the system 300 includes a synchronization component (not shown) that synchronizes the clock or other timing mechanism of the first microphone array 100A with the clock or other timing mechanism of the second microphone array 100B, so that a stream of sampled digital audio from the microphones of array 100A is synchronized with a stream of sampled digital from the microphones of array 100B. The synchronization may produce more accurate TDOA measurements. Any suitable synchronization mechanism can be used. For example, a wired clock signal driving a hardware phase-locked loop can be used to synchronize the microphone arrays 100. In another embodiment, a wireless timestamp-based protocol (e.g., IEEE 802.1AS) driving a software phase-locked loop can be used.

The microphone arrays 100 are able to capture ambient sounds in the environment. The microphones in the microphone arrays 100 may use electromagnetic induction (e.g., dynamic microphone), capacitance change (e.g., condenser microphone), or piezoelectricity (piezoelectric microphone) to produce an electrical signal from air pressure variations. The ambient sounds captured by each of the microphone arrays 100 are sent to the sound event detector component 310.

The sound event detector component 310 detects when a sound event is present, for example by digitally processing the synchronized streams of sampled digital audio streams from the two microphone arrays 100A, 100B. In one embodiment, the sound event detector component 310 determines which ambient sounds should be used for determining the relative location and orientation of the microphone arrays 100 relative to each other. For example, the sound event detector component 310 may determine that ambient sounds (in the sampled digital audio streams of the microphone arrays 100) that have an amplitude below a certain threshold (for any one of the microphone arrays 100) should be discarded. The sound event detector component 310 essentially acts as a gate to decide when a given ambient sound should be used as part of estimating the relative location and orientation of the microphone arrays 100 relative to each other. In one embodiment, the sound event detector component 310 generates a timestamp when it determines that an ambient sound has arrived at the first microphone array 100A, and another timestamp when it determines that the ambient sound has also arrived at the second microphone array 100B. In one embodiment, the microphone arrays 100 include components for generating these timestamps when a sound event is detected. In another embodiment, however, the timestamps can be generated by a third system, based on the third system receiving the sampled digital audio streams that were transmitted from their respective microphone arrays 100A, 100B. The timestamps can be used for determining the TDOA of the ambient sound between the microphone arrays 100.

The measurement component 320 receives the signals representing an ambient sound from the microphone arrays 100 and determines the DOA of the ambient sound at the microphone arrays 100 and the TDOA of the ambient sound between the microphone arrays 100. To this end, the measurement component 320 may include a DOA measurement component 325 and a TDOA measurement component 330. The DOA measurement component 325 measures the DOA of the ambient sound at the microphone arrays 100. The TDOA measurement component 330 measures the TDOA of the ambient sound between the microphone arrays 100. In one embodiment, the TDOA measurement component 330 measures the TDOA of the ambient sound between the microphone arrays 100 based on timestamps that were generated when the ambient sound arrived at the respective microphone arrays. The measurement component 320 can thus produce an observation vector for an ambient sound that includes the DOA of the ambient sound at the first microphone array 100A (θ₁), the DOA of the ambient sound at the second microphone array 100B (θ₂), and the TDOA of the ambient sound between the first microphone array 100A and the second microphone array 100B (Δt). The measurement component 320 can produce observation vectors for multiple sound events (e.g., multiple ambient sounds that are captured by the microphone arrays 100) and pass these observation vectors to the microphone array configuration estimator component 340.

The microphone array configuration estimator component 340 estimates the relative location and orientation of the microphone arrays 100 relative to each other based on the observation vectors received from the measurement component 320. For example, the microphone array configuration estimator 340 may estimate the relative location and orientation of the second microphone array 100B relative to the first microphone array 100A based on observation vectors received from the measurement component 320. In one embodiment, the microphone array configuration estimator component 340 determines the relative location and orientation of the microphone arrays 100 relative to each other by solving or approximating an equation such as Equation 1. Based on this calculation, the microphone array configuration estimator component 340 outputs the relative location (e.g., (r, θ)) and the relative orientation (e.g., φ) of the second microphone array 100A relative to the first microphone array 100A. In one embodiment, the microphone array configuration estimator component 340 also outputs a confidence value that indicates how well the observed data fits into the model. For example, the confidence value can be calculated based on the average absolute difference between ƒ_{r,θ,ϕ}(xᵢ) and yᵢ (e.g., ∥ƒ_{r,θ,ϕ}(xᵢ)−yᵢ∥) or the average least squares difference between ƒ_{r,θ,ϕ}(xᵢ) and yᵢ (e.g., (ƒ_{r,θ,ϕ}(xᵢ)−yᵢ)²). Thus, the system 300 is able to estimate the relative location and orientation of microphone arrays 100 relative to each other without actively producing test sounds.

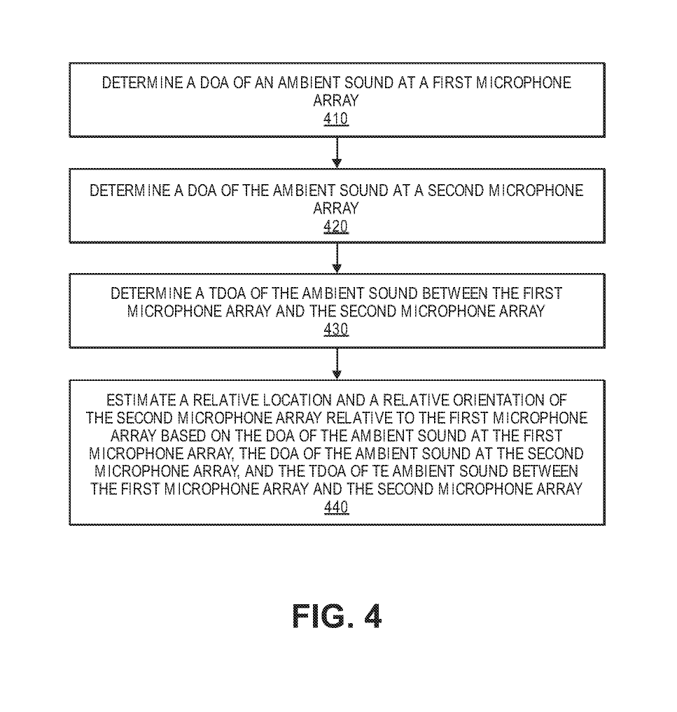

FIG. 4 is a flow diagram illustrating a process for estimating the relative location and orientation of one microphone array relative to another microphone array, according to some embodiments. In one embodiment, the operations of the flow diagram may be performed by various components of the system 300, which, in one embodiment, may be electronic hardware circuitry and/or a programmed processor that is contained within a single consumer electronics product that is separate from the microphone arrays 100A, 100B. In another embodiment, the process described below (and the associated components that perform the process as a whole, as illustrated in FIG. 3) may be within a housing of one of the two microphone arrays 100A, 100B.

In one embodiment, the process is initiated when an ambient sound event is detected. The process determines a DOA of the detected ambient sound at a first microphone array (block 410). Note that such determination may be made in a third device or product, that is separate from the microphone arrays 100A, 100B. The process also determines a DOA of the (detected) ambient sound at a second microphone array (block 420). The process determines a TDOA of the (detected) ambient sound as between the first microphone array 100A and the second microphone array 100B. The process may repeat the operations of blocks 410-430 for additional ambient sound events, to obtain a collection of DOA and TDOA for several different, detected ambient sound events. The process then estimates a relative location and a relative orientation of the second microphone array 100B relative to the first microphone array 100A, based on the collection of DOAs and TDOAs for the several, detected ambient sound events, by for example optimizing the Equation 1 above. Thus, the process estimates the relative location and orientation of microphone arrays 100 relative to each other without actively producing test sounds.

The operations and techniques described herein for estimating a relative location and relative orientation of microphone arrays can be performed in various ways. In one embodiment, each microphone array 100 may include a digital processor (e.g., in the same device housing that also contains its individual microphones) that computes the DOA of an ambient sound and generates a timestamp that indicates when the ambient sound arrived at the microphone array 100. Each microphone array 100 then transmits its computed DOA and timestamp information to a third system (any suitable computer system.) The third system processes such information, that it receives from the respective microphone arrays 100, to estimate a relative location and a relative orientation of the microphone arrays 100. For example, the third system may include a processor and a non-transitory computer readable storage medium having instructions stored therein, that when executed by the processor causes the third system to receive a DOA of an ambient sound at a first microphone array 100A and a timestamp that indicates when the ambient sound arrived at the first microphone array 100A, to receive a DOA of the ambient sound at a second microphone array 100B and a timestamp that indicates when the ambient sound arrived at the second microphone array 100B, to calculate a TDOA of the ambient sound between the first microphone array 100A and the second microphone array 100B based on the timestamp that indicates when the ambient sound arrived at the first microphone array 100A and the timestamp that indicates when the ambient sound arrived at the second microphone array 100B, and to estimate a relative location and a relative orientation of the second microphone array 100B relative to the first microphone array 100A based on the DOA of the ambient sound at the first microphone array 100A, the DOA of the ambient sound at the second microphone array 100B, and the TDOA of the ambient sound between the first microphone array 100A and the second microphone array 100B (e.g., by solving or optimizing Equation 1 in which the computed DOA and TDOA for several different, detected ambient sounds are included to improve the accuracy of the final estimate).

In another embodiment, a digital processor in one microphone array 100A may compute the DOA of an ambient sound and generates a timestamp that indicates when the ambient sound arrived at the microphone array 100, and then transmits its computed DOA and timestamp information to a processor in the other microphone array 100B. The processor of the microphone array 100B (using its own computed DOA and time of arrival timestamp for the same detected ambient sound) then performs the operations that are described above as being performed in the third system, to estimate a relative location and a relative orientation of the microphone arrays 100. In other words, the third system, in this embodiment, is actually one of the microphone arrays 100.

For clarity and ease of understanding, the examples described herein primarily describe an example of determining the relative location and orientation of two microphone arrays 100 relative to each other. However, the techniques described herein can be used to determine relative location and orientation of any number of microphone arrays 100 relative to each other. For example, similar techniques can be used to determine the relative location and orientation of a third microphone array relative to the second microphone array 100B. This information can then be used along with the relative location and orientation of the second microphone array 100B relative to the first microphone array 100A to determine the relative location and orientation of the third microphone array relative to the first microphone array 100A. Also, for clarity and ease of understanding, the examples described herein primarily describe an example of determining the relative location and orientation in a 2D plane. However, the techniques described herein can be modified to extend to 3D space.

An embodiment may be an article of manufacture in which a machine-readable storage medium has stored thereon instructions which program one or more data processing components (generically referred to here as a “processor”) to perform the operations described above. Examples of machine-readable storage mediums include read-only memory, random-access memory, non-volatile solid state memory, hard disk drives, and optical data storage devices. The machine-readable storage medium can also be distributed over a network so that software instructions are stored and executed in a distributed fashion. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art.

1. A method for estimating relative location and relative orientation of microphone arrays relative to each other without actively producing test sounds, comprising:
determining a first direction from which an ambient sound is received at a first microphone array, wherein the ambient sound is received at the first microphone array at a first time;
determining a second direction from which the ambient sound is received at a second microphone array, wherein the ambient sound is received at the second microphone array at a second time;
determining a difference between the first and second times at which the ambient sound is received at the first microphone array and the second microphone array; and
estimating a relative location and a relative orientation of the second microphone array relative to the first microphone array based on the first direction from which the ambient sound is received at the first microphone array, the second direction from which the ambient sound is received at the second microphone array, and the difference between the first and second times at which the ambient sound is received at the first microphone array and the second microphone array.

2. The method of claim 1, further comprising:
synchronizing a clock of the first microphone array with a clock of the second microphone array.

3. The method of claim 2, further comprising:
generating a timestamp when the ambient sound arrives at the first microphone array; and
generating a timestamp when the ambient sound arrives at the second microphone array.

4. The method of claim 1, further comprising:
determining a confidence value for the estimated relative location and relative orientation of the second microphone array relative to the first microphone array.

5. The method of claim 1, wherein estimating the relative location and the relative orientation of the second microphone array relative to the first microphone array is based on measurements of at least three different ambient sounds originating from different locations, wherein each measurement of an ambient sound includes 1) a respective direction and time at which that ambient sound is received at the first microphone array, 2) a respective direction and time at which that ambient sound is received at the second microphone array, and 3) a difference between the respective times at which the ambient sound is received at the first microphone array and the second microphone array.

6. The method of claim 5, wherein estimating the relative location and the relative orientation of the second microphone array relative to the first microphone array comprises:
minimizing an average distance between the measurements and an image of a function that maps sound locations to expected values of a direction and a time at which a sound is received for a given microphone array configuration, wherein the function is parametrized on the relative location and the relative orientation of the second microphone array relative to the first microphone array.

7. The method of claim 1, wherein the relative location is expressed in terms of 1) a distance between the first microphone array and the second microphone array and 2) an angle between a front reference axis of the first microphone array and a line that connects the first microphone array to the second microphone array, and wherein the relative orientation is expressed in terms of an angle between the front reference axis of the first microphone array and a front reference axis of the second microphone array.

8. The method of claim 1, wherein the first microphone array includes at least three microphones and the second microphone array includes at least three microphones.

9. A system for estimating relative location and relative orientation of microphone arrays relative to each other without actively producing test sounds, comprising:
a first microphone array;
a second microphone array;
means for determining a DOA of an ambient sound at the first microphone array and means for determining a DOA of the ambient sound at the second microphone array;
means for determining a TDOA of the ambient sound between the first microphone array and the second microphone array; and
means for estimating a relative location and a relative orientation of the second microphone array relative to the first microphone array based on the DOA of the ambient sound at the first microphone array, the DOA of the ambient sound at the second microphone array, and the TDOA of the ambient sound between the first microphone array and the second microphone array.

10. The system of claim 9, further comprising:
means for synchronizing a clock of the first microphone array with a clock of the second microphone array.

11. The system of claim 10, wherein the means for estimating the relative location and the relative orientation of the second microphone array relative to the first microphone array is based on making measurements of at least three different ambient sounds originating from different locations, wherein each measurement of an ambient sound includes 1) a DOA of that ambient sound at the first microphone array, 2) a DOA of that ambient sound at the second microphone array, and 3) a TDOA of that ambient sound between the first microphone array and the second microphone array.

12. The system of claim 11 wherein the means for estimating the relative location and the relative orientation minimizes an average distance between the measurements and an image of a function that maps sound locations to expected values of DOA and TDOA for a given microphone array configuration, wherein the function is parameterized on the relative location and the relative orientation of the second microphone array relative to the first microphone array.

13. A computer system for estimating relative location and relative orientation of microphone arrays relative to each other without actively producing test sounds, comprising:
a processor; and
a non-transitory computer readable storage medium having instructions stored therein, the instructions when executed by the one or more processors causes the computer system to
receive a direction-of-arrival (DOA) of an ambient sound at a first microphone array and a timestamp that indicates when the ambient sound arrived at the first microphone array,
receive a DOA of the ambient sound at a second microphone array and a timestamp that indicates when the ambient sound arrived at the second microphone array,
calculate a time-difference-of-arrival (TDOA) of the ambient sound between the first microphone array and the second microphone array based on the timestamp that indicates when the ambient sound arrived at the first microphone array and the timestamp that indicates when the ambient sound arrived at the second microphone array, and
estimate a relative location and a relative orientation of the second microphone array relative to the first microphone array based on the DOA of the ambient sound at the first microphone array, the DOA of the ambient sound at the second microphone array, and the TDOA of the ambient sound between the first microphone array and the second microphone array.

14. The computer system of claim 13, wherein the instructions when executed by the computer system further cause the computer system to:
synchronize a clock of the first microphone array with a clock of the second microphone array.

15. The computer system of claim 13, wherein the instructions are such that estimating the relative location and the relative orientation of the second microphone array relative to the first microphone array is based on making measurements of at least three different ambient sounds originating from different locations, wherein each measurement of an ambient sound includes 1) a DOA of that ambient sound at the first microphone array, 2) a DOA of that ambient sound at the second microphone array, and 3) a TDOA of that ambient sound between the first microphone array and the second microphone array.

16. The computer system of claim 15, wherein the instructions when executed by the computer system further cause the computer system to:
minimize art average distance between the measurements and an image of a function that maps sound locations to expected values of DOA and TDOA for a given microphone array configuration, wherein the function is parametrized on the relative location and the relative orientation of the second microphone array relative to the first microphone array.

17. 21. The computer system of claim 13 wherein the instructions cause the computer system to determine the TDOA of the ambient sound between the first microphone array and the second microphone array based on a timestamp generated when the ambient sound arrived at the first microphone array and a timestamp generated when the ambient sound arrived at the second microphone array.

18. The computer system of claim 13, wherein the instructions are such that the relative location is expressed in terms of 1) a distance between the first microphone array and the second microphone array and 2) an angle between a front reference axis of the first microphone array and a straight line that connects the first microphone array to the second microphone array, and wherein the relative orientation is expressed in terms of an angle between a front reference axis of the first microphone array and a front reference axis of the second microphone array.

19. The computer system of claim 13, wherein the instructions cause the computer system to calculate a confidence value for the estimated relative location and relative orientation of the second microphone array relative to the first microphone array.

20. The computer system of claim 13, wherein the instructions cause the computer system to treat the first microphone array as having at least three microphones and the second microphone array as having at least three microphones.
